(19) United States
(12) Patent Application Publication
(10) Pub. No.: US 2018/0316818 A1
(43) Pub. Date: Nov. 1, 2018

(54) SYSTEM AND METHOD FOR INSTALLING APPLICATION AND RECORDING MEDIUM

(71) Applicant: Shigeo Negoro, Tokyo (JP)

(72) Inventor: Shigeo Negoro, Tokyo (JP)

(73) Assignee: Ricoh Company, Ltd., Tokyo (JP)

(21) Appl. No.: 15/966,281

(22) Filed: Apr. 30, 2018

(30) Foreign Application Priority Data
May 1, 2017 (JP) 2017-091212

(51) Int. Cl. H04N 1/00; G06F 8/61; G06F 3/0481; G06F 3/12

(52) U.S. Cl. CPC H04N 1/00938; G06F 8/61; H04N 2201/0094; G06F 3/123; G06F 3/04817

(57) ABSTRACT

A system for installing application includes: one or more processors; and one or more computer-readable media storing instructions which, when processed by the one or more processors, cause the processors to receive a request for installing an application onto an execution device, the execution device being configured to execute one or more applications; determine, in response to receiving the installation request, whether the application to be installed is subject to prompt installation or activation-time installation; generate a dummy icon based on a determination that the application to be installed is subject to activation-time installation; store, in a memory, the application of which the dummy icon is generated; receive a request for activating the application through the generated dummy icon; and install and activate the application stored in the memory in response to receiving the activation request through the dummy icon.

### CROSS-REFERENCE TO RELATED APPLICATIONS

This patent application is based on and claims priority pursuant to 35 U.S.C. § 119(a) to Japanese Patent Application No. 2017-091212, filed on May 1, 2017, in the Japan Patent Office, the entire disclosure of which is hereby incorporated by reference herein.

### BACKGROUND

### Technical Field

The present invention relates to a system and method for installing application, and a recording medium.

### Discussion of the Background Art

The multifunction peripheral (MFP) is pre-installed with basic software, which controls hardware of the multifunction peripheral to provide functions such as scanning and copying. The functions of the MFP may be extended by installing an application from a server or a recording medium on the MFP.

For example, in using the function of the MFP such as copying, the user may download a script of a user-specific plug-in application from the server to the MFP for installation. In this way, the functions of the MFP may be customized specific to the user.

### SUMMARY

Embodiments of the present invention include a system for installing application, which includes: one or more processors; and one or more computer-readable media storing instructions which, when processed by the one or more processors, cause the processors to receive a request for installing an application onto an execution device, the execution device being configured to execute one or more applications; determine, in response to receiving the installation request, whether the application to be installed is subject to prompt installation or activation-time installation; generate a dummy icon based on a determination that the application to be installed is subject to activation-time installation; store, in a memory, the application of which the dummy icon is generated; receive a request for activating the application through the generated dummy icon; and install and activate the application stored in the memory in response to receiving the activation request through the dummy icon.

Embodiments of the present invention include a method for installing application, and a non-transitory recording medium storing a control program for installing application.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a view illustrating an external configuration of an MFP, as an example of an image processing apparatus according to an embodiment of the present invention;

FIG. 2 is a block diagram illustrating an example of a hardware configuration of the MFP illustrated in FIG. 1;

FIG. 3 is a block diagram illustrating an example of a functional configuration of an operation unit of the MFP illustrated in FIG. 1;

FIG. 4 is a block diagram illustrating an example of the functional configuration of the operation unit relating to installation;

FIG. 5 is a diagram illustrating an example of a data configuration of an information file provided in each target app according to the embodiment of the present invention;

FIG. 6 is a diagram illustrating an example of a data configuration of a management table that is used by an installation processor for management of saving apps according to the embodiment of the present invention;

FIG. 7 is a diagram illustrating an example of a sequence performed in the operation unit for installing a target app according to the embodiment of the present invention;

FIG. 8 is a diagram illustrating an example of screen transition in a case where a touch-operation is provided on an icon on a home screen according to the embodiment of the present invention;

FIG. 9 is a flowchart illustrating an example of a process performed in a launcher according to a first variation example of the embodiment for recording activation date/time;

FIG. 10 is a diagram illustrating an example of a process for determination regarding activation frequency and re-saving according to the first variation example of the embodiment;

FIG. 11 is a diagram illustrating an example of a configuration screen according to a second variation example of the embodiment;

FIG. 12 is a flowchart illustrating an example of a process flow of the process performed by an installer; and

FIG. 13 is a block diagram illustrating an example of the functional configuration of the operation unit relating to installation, according to the first variation example of the embodiment.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

To customize the basic functions of the MFP specific to the user, the user may select a specific application for installation onto the MFP. The specific application may be selected, for example, based on selection of a specific function available on the MFP. In the background installation method, the application is promptly installed when the application corresponding to the MFP, which may be the application selected by the user, is identified and installation is approved. This may sometimes increase the start-up time of the MFP. For example, when the application has such a setting that causes a delay in the start-up time of the MFP, e.g., in a case where the application has such a setting that causes the application to be activated with activation of an operation system (OS), the setting directly affects the start-up time of the MFP.

Hereinafter, with reference to the accompanying drawings, one or more embodiments of an image processing apparatus, an image processing method, and an image processing control program stored on a recording medium are explained in detail.

### First Embodiment

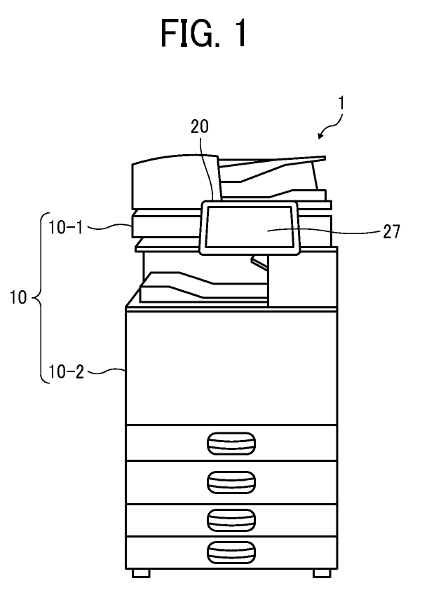

FIG. 1 is a view illustrating an external configuration of an MFP, as an example of the image processing apparatus according to the present embodiment. The MFP of FIG. 1 is provided with at least two of various types of functions such as a copy function, a scanner function, a facsimile function, and a printer function. The following description explains, as an example, the MFP that is provided with a copy function and a scanner function.

The MFP 1 illustrated in FIG. 1 includes a main unit 10 and an operation unit 20. The main unit 10 includes a scanner unit 10-1 that scans a document into a scanned image, and an image forming unit 10-2 that forms an image on a medium for recording such as a piece of paper based on the scanned image.

The operation unit 20 includes a control panel 27, which accepts a user operation. Here, the concept of “accept a user operation” includes accepting information (including a signal indicative of a coordinate value of a screen, etc.) that is input in response to a user operation. The operation unit 20 is installed with various types of applications for allowing a user to utilize services provided by the main unit 10. The operation unit 20 obtains an additional application from a network, a removable recording medium, etc., for installation. In the drawings, there may be a case where an “application” is abbreviated to an “app”. The operation unit 20 is an example of an execution device for activating an application.

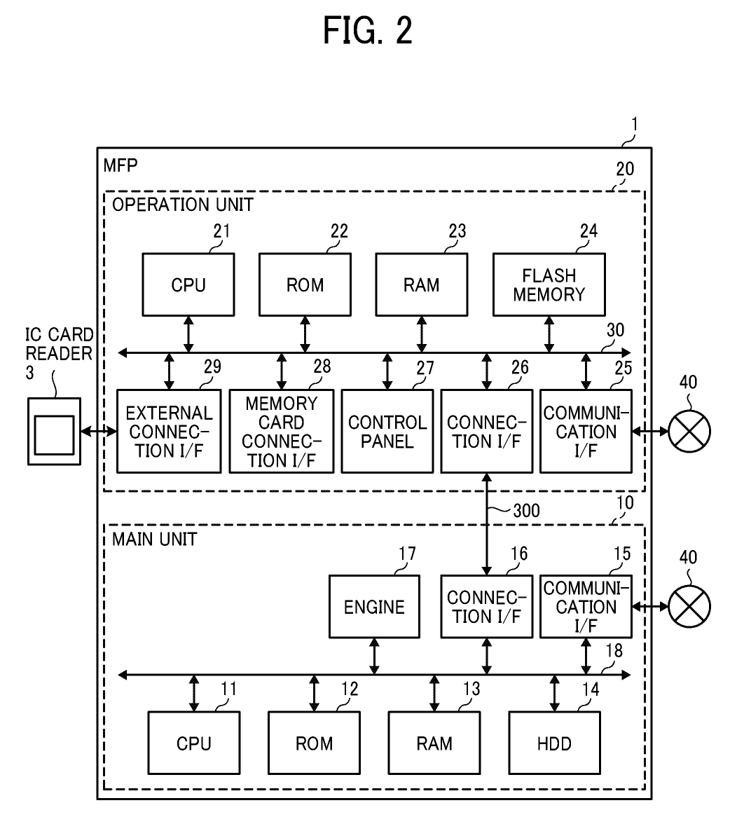

An operation of the main unit 10 through the operation unit 20 is performed via a communication path 300 (c.f., FIG. 2) that connects the main unit 10 and the operation unit 20. Various types of operations through the operation unit 20 are performed by use of an application programming interface (API) that is provided by the main unit 10. The “API” is exemplified by a Web API, etc.

(Hardware Configuration)

FIG. 2 is a block diagram illustrating an example of a hardware configuration of the MFP 1. As illustrated in FIG. 2, the main unit 10 and the operation unit 20 are capable of communicating with each other vie the communication path 300. The communication path 300 is a wired or wireless communication path. Regarding the MFP 1, the hardware configuration of the main unit 10 is firstly explained, and then the hardware configuration of the operation unit 20 is explained.

As illustrated in FIG. 2, the main unit 10 includes a central processing unit (CPU) 11, a read only memory (ROM) 12, a random access memory (RAM) 13, a hard disk drive (HDD) 14, a communication interface (I/F) 15, a connection I/F 16, and an engine 17, which are mutually connected via a system bus 18.

The CPU 11 controls entire operation of the main unit 10. The CPU 11 uses the RAM 13 as a work area and executes a program that is stored in the ROM 12, the HDD 14, etc., to control an operation of the entire main unit 10.

The communication I/F 15 is an interface in compliance with such as an Ethernet (registered trademark) standard, which connects the main unit 10 to a network 40 such as a local area network (LAN).

The connection I/F 16 is an interface in compliance with such as a Universal Serial Bous (USB) standard, which communicates with the operation unit 20 via the communication path 300.

The engine 17 includes an image processing engine that performs a scanning process and an image forming engine that performs an image forming process, and executes a scanning process, a copy process, etc.

Next, the hardware configuration of the operation unit 20 is described. As illustrated in FIG. 2, the operation unit 20 is provided with a CPU 21, a ROM 22, a RAM 23, a flash memory 24, a communication I/F 25, a connection I/F 26, a control panel 27, a memory card connection I/F 28, and an external connection I/F 29, which are mutually connected via a system bus 30.

The CPU 21 generally controls an operation of the operation unit 20. The CPU 21 uses the RAM 23 as a work area and executes a program that is stored in the ROM 22 or the flash memory 24, to control the entire operation unit 20.

The communication I/F 25 is an interface in compliance with such as a wireless LAN standard, which connects to the network 40.

The connection I/F 26 is an interface in compliance with such as a USB standard, which communicates with the main unit 10 via the communication path 300.

The control panel 27 includes a liquid crystal display (LCD) that displays various information and a touchscreen that detects a touched position (i.e., coordinates information) on the screen. The LCD displays information that is output from the CPU 21, and the touchscreen notifies the CPU 21 of coordinates information of a touched position. Note that, although an LCD is taken as an example here, it is also possible to employ another display method such as an organic electro-luminescence (EL). Furthermore, in addition to or instead of a touchscreen, it is also possible that a hardware key for an operation purpose is provided.

The memory card connection I/F 28 is an interface for connecting the operation unit 20 to a memory card such as a secure digital (SD) card.

The external connection I/F 29 is an interface for connecting the operation unit 20 to an integrated circuit (IC) card reader 3. The IC card reader 3 may be used to read information from an IC card for authentication of a log-in user, etc.

(Functional Configuration of the Operation Unit)

On the operation unit 20, a common function or an additional function is implemented by a program that is read by the CPU 21 onto the RAM 23 for execution.

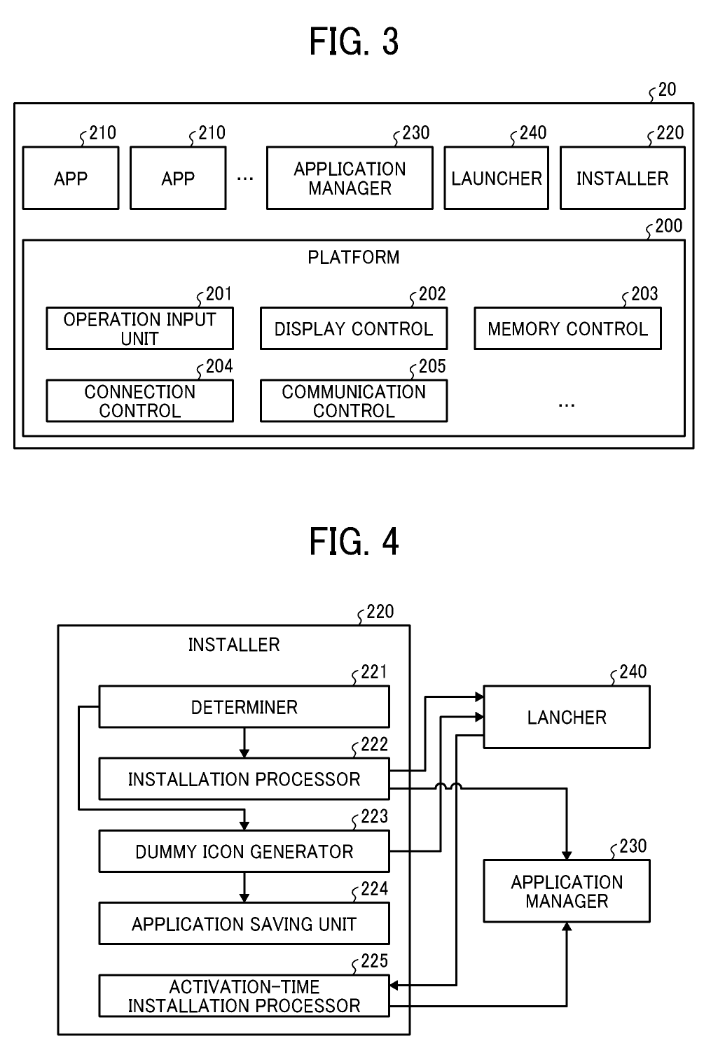

FIG. 3 is a block diagram illustrating a functional configuration of the operation unit 20. As illustrated in FIG. 3, the operation unit 20 implements a platform 200 including common functions such as an OS and various types of middleware. On the application layer of the platform 200, there are actualized an installed application 210 (“APP”), an installer 220 that performs installation of the application 210, and utility software such as an application manager 230 and a launcher 240. Utility software and a part of applications 210, etc., are activated together with an above-described common function.

The application manager 230 manages an installation state of an application. The launcher 240 manages operation to an icon on the “home screen” or the “application-list screen”. For example, when an icon on the “home screen” or the “application-list screen” is touched, the launcher 240 activates an application 210 that corresponds to the icon touched by a user.

As the above-described common functions provided to the application layer, the platform 200 includes an operation input unit 201, a display control 202, a memory control 203, a connection control 204, a communication control 205, etc.

The operation input unit 201 accepts an input (e.g., coordinates information) from the control panel 27 and instructs a corresponding unit to execute a process that corresponds to the accepted content. For example, in a case of accepting an operation for an installation process, the operation input unit 201 instructs the installer 220 to perform the process. In a case where the input is a touch-operation on an icon of the screen, the operation input unit 201 instructs the launcher 240 to activate an application corresponding to the icon. In a case where the input is a touch-operation on a dummy icon, which is described below, the operation input unit 201 provides an instruction in accordance with the content defined for the dummy icon. Such an instruction in accordance with content defined for a dummy icon is described below.

The display control 202 controls display of the control panel 27. For example, the display control 202 displays a home screen, which is embedded in the OS, an application-list screen, and a notification screen, which is provided from the installer 220.

The memory control 203 reads or writes information from or to the ROM 22, the RAM 23, the flash memory 24, or a memory card via the memory card connection I/F 28.

The connection control 204 controls the connection I/F 26 to communicate with the main unit 10.

The communication control 205 controls the communication I/F 25 to communicate with a communication device on the network 40.

Note that, although the application layer arbitrates and utilizes each resource via the above-described common functions in such a process relating to installation as described below, explanations of the common functions are omitted, as appropriate, for ease of the explanations.

FIG. 4 is a block diagram illustrating an example of the functional configuration of the operation unit 20 relating to installation. As illustrated in FIG. 4, the installer 220 includes a determiner 221, an installation processor (i.e., a prompt installation processor) 222, a dummy icon generator 223, an application saving unit 224, and an activation-time installation processor 225.

The determiner 221 accepts from the operation input unit 201 an instruction to install an application (hereinafter referred to as a “target app”) that is an installation target and accepts from the OS, etc., an instruction to install an automatically detected target app. Further, the determiner 221 determines whether such a target app is subject to prompt install or activation-time install. Here. “prompt install” indicates performing installation without performing a below-described “saving” process upon an installation instruction. Further, “activation-time install” indicates performing the “saving” process first and then performing installation upon an activation instruction. In addition, a target app includes an application package file that constitutes a function of the application and an information file that is indicative of an attribute of the target app. In the present embodiment, a developer of a target app sets an attribute of the target app in an information file in advance. The determiner 221 retrieves the attribute in the information file, to determine whether the target app is subject to prompt install or activation-time install.

The installation processor 222 performs prompt install of a target app that is determined by the determiner 221 to be subject to prompt install. Specifically, the installation processor 222 decompresses an application package file on the RAM 23 and performs a series of installation processes such as setting a relevant file, etc., storing various types of files and an information file of the application in any desired directory, registering an icon on the launcher 240, and notifying the application manager 230 of completion of the installation.

The dummy icon generator 223 generates a dummy icon of a target app (i.e., a saving app) that is determined by the determiner 221 to be subject to activation-time install and registers the generated dummy icon on the launcher 240.

The application saving unit 224 saves an installation package of a saving app in a saving memory. Here, the “saving memory” indicates a memory area for saving, which is allocated on the flash memory 24 via the memory control 203 in advance. Further, “saving” means temporarily storing in the saving memory.

Upon a touch-operation on a dummy icon of the screen to instruct to activate a saving app, the activation-time installation processor 225 retrieves an installation package of the saving app from the saving memory and performs an installation process, to activate the application. In the present embodiment, as an example, upon accepting from a dummy icon a call for a screen, such as a now-calling screen, the activation-time installation processor 225 displays a corresponding screen and performs an installation process of a saving app on the background. Upon completion of the installation process, the activation-time installation processor 225 notifies the application manager 230 of completion of the installation.

Note that the dummy icon that is registered on the launcher 240 is deleted from the launcher 240 upon the first-time touch-operation.

(Data Configuration)

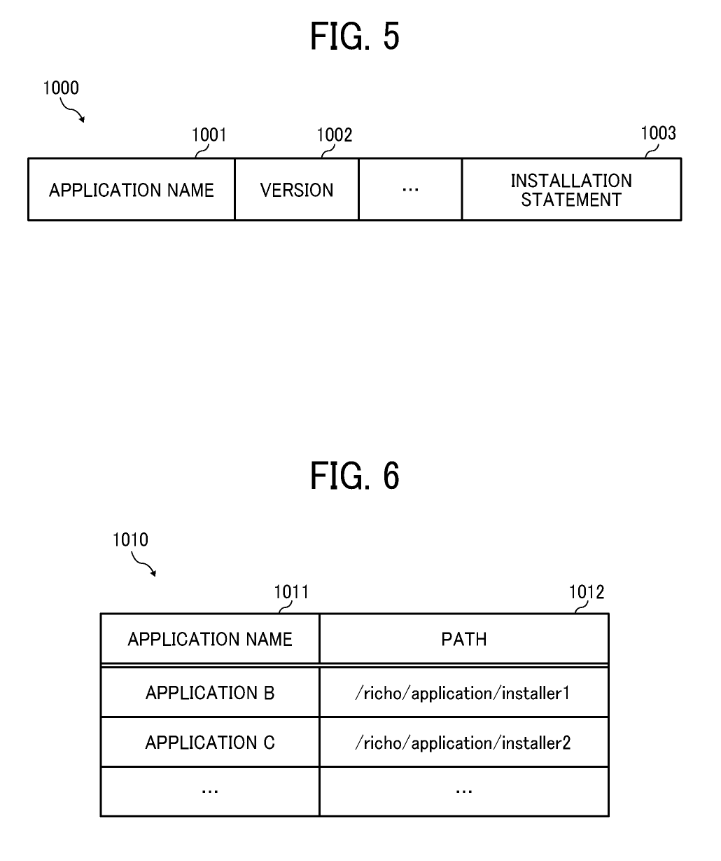

FIG. 5 is a diagram illustrating an example of a data configuration of an information file provided in each target app. As for the information file 1000 illustrated in FIG. 5, it is possible to set up information indicating an “installation statement” 1003, in addition to various types of attribute information such as information indicating an “application name” 1001 and information indicating a “version” 1002. As an “installation statement” 1003, a developer, etc., of a target app sets information indicating either one of “prompt install” and “activation-time install”.

FIG. 6 is a diagram illustrating an example of a data configuration of a management table that is used by the installation processor 222 for management of saving apps. In the management table 1010 illustrated in FIG. 6, an “application name” 1011 of a saving app that is saved in the saving memory and a “path” 1012 of the saving app are associated with each other.

(Process Sequence of the Operation Unit)

Next, the process sequence of the operation unit 20 relating to installation is described according to an embodiment. The operation unit 20 performs installation of a target app in the following way upon detecting, from a memory card, an application server on a network, etc., an application (i.e., the target app) that is an installation target.

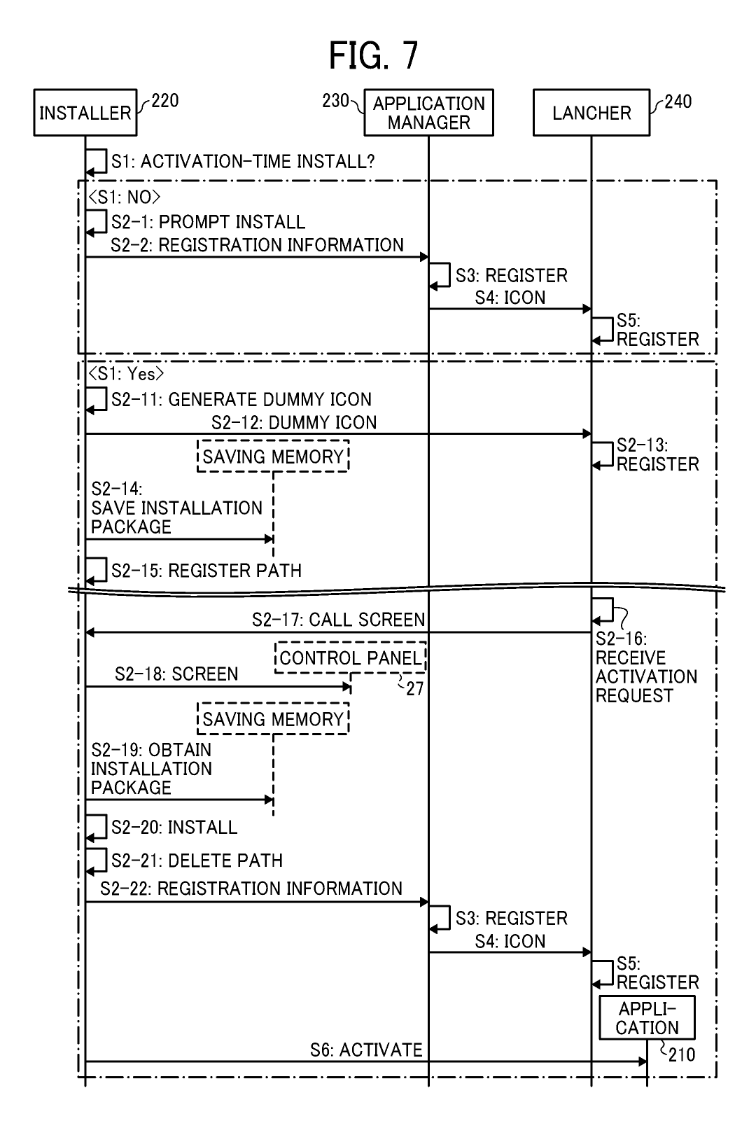

FIG. 7 is a diagram illustrating an example of a sequence performed in the operation unit 20 for installing a target app. Firstly, the installer 220 (i.e., the determiner 221) of the operation unit 20 retrieves attribute information that is set in the information file 1000 (c.f., FIG. 5) of the target app and determines whether the target app is set with “activation-time install” (S1).

In a case where the target app is not set with “activation-time install”, in other words, in a case where the target app is set with “prompt install” (S1: NO), the installer 220 (i.e., the installation processor 222) performs prompt install (S2-1).

Upon completion of the installation, the installer 220 (i.e., the installation processor 222) notifies the application manager 230 of completion of the installation in such a way as providing registration information of the target app (S2-2).

Upon receiving the notification from the installer 220, the application manager 230 registers the registration information (i.e., bibliographic information) of the target app as an installed application and starts management of the target app (S3). For example, the application manager 230 registers registration information (i.e., bibliographic information) in a registration table and manages the target app.

Subsequently, the application manager 230 provides the launcher 240 with registration-list information (i.e., icon information, an application name, etc.) of the target app, which is managed as an installed application (S4).

The launcher 240 registers, on the “home screen” or the “application-list screen”, the registration-list information that is received from the application manager 230 (S5). For example, in a case where an icon that is not registered on the “home screen” or the “application-list screen” is included in the registration-list information, the launcher 240 additionally registers the icon and the application name. Furthermore, as for the icons that are registered in the launcher 240, in a case where there is an icon that has been deleted in the registration-list information, the launcher 240 deletes the icon and the application name. Note that a dummy icon that is registered in the launcher 240 is kept registered regardless of contents of the registration-list information.

Then, when a touch-operation is provided by a user on an icon of the “home screen” or the “application-list screen”, the launcher 240 activates an application corresponding to the icon.

Contrarily, in a case where the target app is subject to “activation-time install” (S1: Yes), the operation unit 20 performs the following process. Firstly, the installer 220 (i.e., the dummy icon generator 223) generates a dummy icon of the target app (i.e., a saving app) (S2-11) and transmits the dummy icon to the launcher 240 (S2-12). In the present embodiment, a screen provided by the installer 220 is designated as an example of a call target for the dummy icon.

Upon receiving the dummy icon from the installer 220, the launcher 240 registers the dummy icon and the application name of the saving app corresponding to the dummy icon (S2-13). The application name of the saving app is retrieved from the information file 1000 by the determiner 221 at the step S1.

Furthermore, instead of installing an application package file and an information file of the saving app, the installer 220 (i.e., the application saving unit 224) saves such an installation package in a designated path of the saving memory (S2-14).

Furthermore, the installer 220 (i.e., the application saving unit 224) registers in the management table 1010 (c.f., FIG. 6) the application name and the designated path in association as information of the saving app (S2-15).

Then, when a touch-operation is provided by a user on the dummy icon of the “home screen” or the “application-list screen” as an instruction for activation, the launcher 240 accepts activation of the dummy icon (S2-16). Furthermore, based on the acceptance, the operation unit 20 installs and activates the saving app corresponding to the dummy icon in the following way.

First, the launcher 240 calls the screen provided by the installer 220 in accordance with definition designated to the operated dummy icon (S2-17). When calling the screen, the launcher 240 provides the installer 220, as additional information, with the application name corresponding to the dummy icon on which the touch-operation has been provided. At the same time, the dummy icon may be deleted from the launcher 240. Alternatively, as explained below, the dummy icon may be replaced with a genuine icon, which is registered in the launcher 240 when installing the saving app.

In response to the calling of the screen from the launcher 240, the installer 220 (i.e., the activation-time installation processor 225) generates a notification screen, which may be a now-calling screen that indicates that the screen is being called, such as “Please wait . . . ”, and outputs the notification screen to the display control 202 (S2-18). That is to say, the notification screen is displayed on the control panel 27.

Furthermore, the installer 220 (i.e., the activation-time installation processor 225) executes a process on the background of the displayed notification screen, to obtain the installation package of the saving app corresponding to the dummy icon (S2-19) and install the saving app (S2-20). In the example of the present embodiment, the installer 220 (i.e., the activation-time installation processor 225) utilizes the additional information (i.e., the application name), which has been received from the launcher 240, to obtain from the management table 1010 (c.f., FIG. 6) the path that corresponds to the application name. Furthermore, the installer 220 (i.e., the activation-time installation processor 225) obtains from the path the installation package of the saving app.

Upon completion of the installation, the installer 220 (i.e., the activation-time installation processor 225) deletes a record (i.e., the application name and the designated path) corresponding to the saving app from the management table 1010 (S2-21).

Furthermore, the installer 220 (i.e., the activation-time installation processor 225) provides the application manager 230 with registration information of the saving application (i.e., a target app), to notify the application manager 230 of completion of the installation (S2-22).

Upon receiving the notification from the installer 220, the application manager 230 registers as an installed application the registration information (i.e., bibliographic information) of the target app and starts management of the target app (S3).

Furthermore, the application manager 230 provides the launcher 240 with registration-list information (i.e., icon information, an application name, etc.) of the target app, which is managed as an installed application (S4).

The launcher 240 registers on the “home screen” or the “application-list screen” the registration-list information that is received from the application manager 230 (S5). In a case where there is an icon having the same application name as the dummy icon activated by the launcher 240, the dummy icon is replaced with the icon.

Subsequently, the installer 220 (i.e., the activation-time installation processor 225) calls and activates the target app (S6). Note that the installer 220 closes a now-calling screen at any desired timing by the time when calling of the target application ends.

Then, when a touch-operation is provided by a user on the icon of the “home screen” or the “application-list screen”, with which the dummy icon has been replaced, the launcher 240 promptly activates the application corresponding to the icon.

Next, the following description explains screen transition in a case where a touch-operation is provided on an icon. Here, as an example, screen transition in a case where a touch-operation is provided on an icon on the home screen is explained.

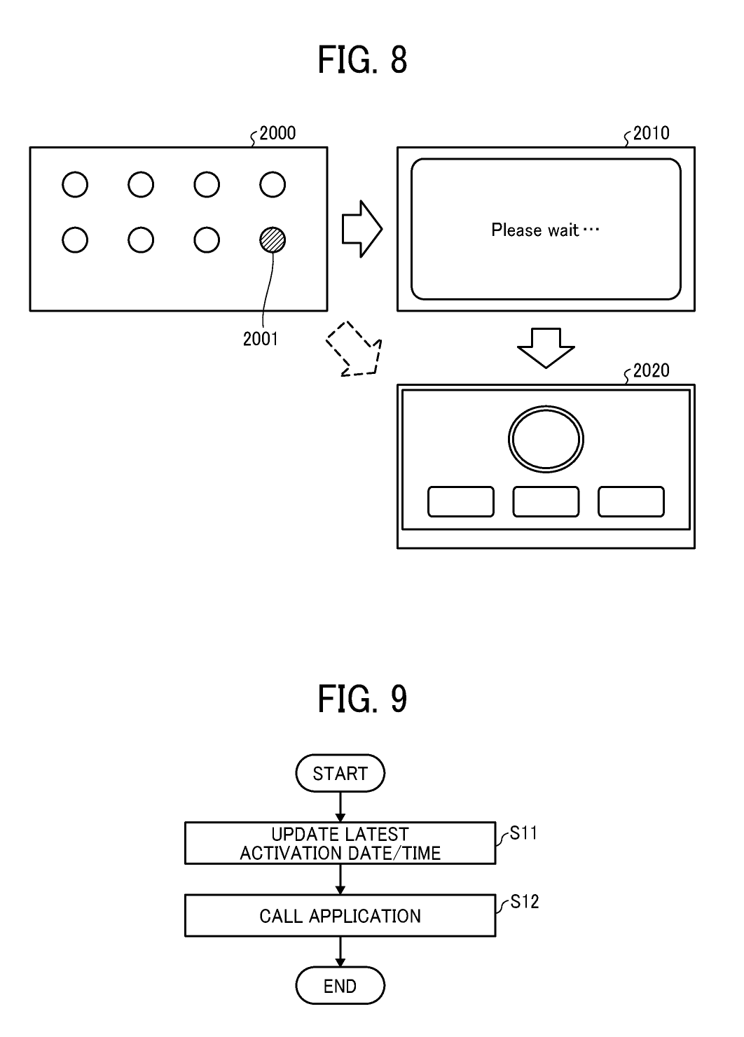

FIG. 8 is a diagram illustrating an example of screen transition in a case where a touch-operation is provided on an icon on the home screen. On the home screen 2000 illustrated in FIG. 8, various icons for activating an application are illustrated. In FIG. 8, for the sake of explanation, the dummy icon of a saving app is illustrated in an appearance that is different from installed icons. Dummy icons may be displayed as the same type of icons that are not distinguishable by appearance from installed icons or may be displayed as icons that are distinguishable by appearance from installed icons.

In a case where a user provides a touch-operation on the dummy icon 2001 of the home screen 2000, a calling screen is called because the dummy icon 2001 corresponds to a saving app. As a result, the now-calling screen 2010 as indicated by the solid arrow is displayed. While the now-calling screen 2010 is being displayed, an installation process of the saving app is performed on the background. Upon completion of the installation, the application of the saving app is activated. As a result, transition from the now-calling screen 2010 to a menu screen 2020 of the application is performed as indicated by the solid arrow.

In a case where a user provides a touch-operation on the icon 2001 of the home screen 2000 for the second time, as the application has already been installed, the application is promptly activated in the same way as the other icons that have already been installed. As a result, transition to the menu screen 2020 of the application is performed as indicated by the dashed arrow in FIG. 8.

As described above, in the present embodiment, in a case where there are applications that are installation targets, prompt install is not performed as for an application that is set up to be subject to activation-time install. In this way, only the minimum number of applications necessary are installed on the operation unit 20, which means that it is possible to decrease the number of applications to be activated. This prevents increase in the start-up time of the operation unit 20.

In addition, in the present embodiment, an icon of a saving app is displayed as a dummy on the screen of the operation unit 20. Therefore, it is possible for a user to recognize the existence of the application. Furthermore, as the application is not installed until an activation operation through a first-time touch-operation, etc., is provided on the icon, it is possible to shorten the start-up time of the operation unit 20 by the amount of the application as long as an activation operation is not provided by a user. Additionally, although an activation operation is provided at a later time, it is possible to reduce the start-up time of the operation unit 20 during the usage period until the later time.

Furthermore, in a case where a touch-operation is provided on a dummy icon, an installation process is executed on the background while a notification screen is displayed. Therefore, it is possible to activate the application with barely changing operability from installed applications.

### First Variation Example

The following description explains the first variation example in which activation frequency of an installed application is recorded and, in a case where the activation frequency does not meet a predetermined condition, the application is saved again. The following description mainly explains parts that are different from the above-described embodiment. Furthermore, parts that are in common with the above-described embodiment are assigned the same reference signs, etc., such that explanation is omitted as appropriate. The predetermined condition may be set by a service provider or a user, for example.

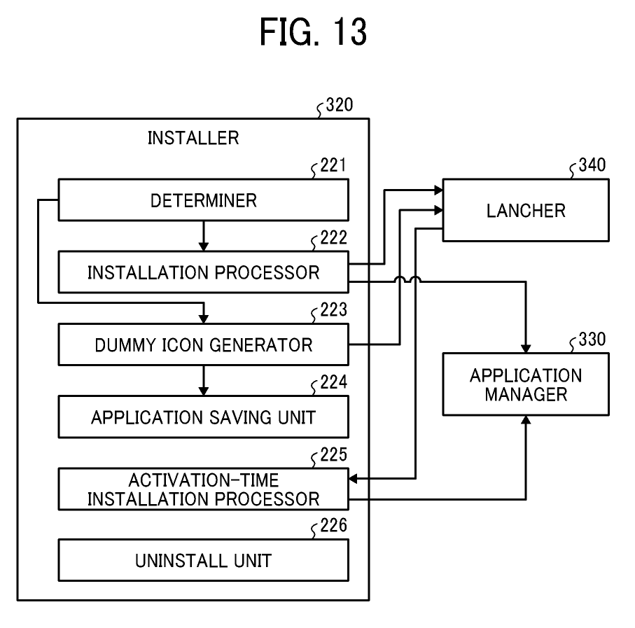

As illustrated in FIG. 13, an operation unit 20 according to the first variation example functions as a recorder, a determiner, and a re-save unit. The recorder records activation frequency of an installed application. The determiner determines an application to be saved again, based on activation frequency recorded by the recorder. The re-save unit saves again an application as determined by the determiner.

More specifically, as illustrated in FIG. 13, compared to the launcher 240 of the above-described embodiment in FIG. 4, a launcher 340 further includes a function (i.e., an example of the recorder) for recording activation date/time (i.e., an example of “activation-frequency information”) of an application.

Furthermore, compared to the application manager 230 according to the above-described embodiment in FIG. 4, an application manager 330 further includes a function (i.e., an example of the determiner) for referring to the launcher 340 for activation date/time of each installed application and determining an application to be saved again.

Furthermore, compared to the installer 220 according to the above-described embodiment in FIG. 4, an installer 320 further includes an uninstall unit 226 (i.e., an uninstaller) for uninstalling an installed application. The uninstall unit 226 and the application saving unit 224 respectively include functions as an example of the re-save unit, with which an installed application is uninstalled and saved again as a saving app.

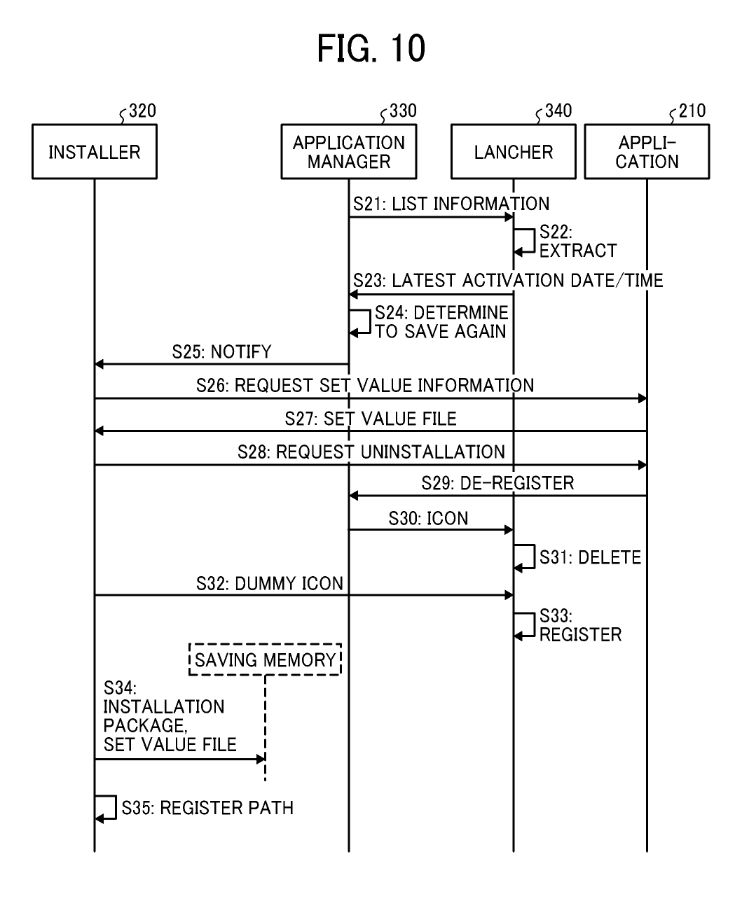

FIG. 9 and FIG. 10 are figures illustrating an example of a process performed in the operation unit 20 according to the first variation example for saving an installed application again.

(Update of Activation Date/Time)

FIG. 9 is a flowchart illustrating an example of a process performed in the launcher 340 for recording activation date/time. When a touch-operation is provided by a user on an icon on the home screen, the launcher 340 obtains date/time information from the OS (i.e., time keeper) of the operation unit 20A, to record the latest activation date/time of the icon on which the operation for activation is provided (S11). Furthermore, the launcher 340 calls a corresponding application for prompt activation (S12).

The launcher 340 executes the processes of the steps S11 and S12 every time an operation for activation is provided, so as to constantly keep activation date/time of each application in the latest state.

(Determination Regarding Activation Frequency)

FIG. 10 is a diagram illustrating an example of a process for determination regarding activation frequency and re-saving. Firstly, the application manager 330 extracts the application name of each installed application, which is registered in the management table 1010 (c.f., FIG. 6), and transmits the list of application names to the launcher 340 to request for the latest activation date/time of each application (S21). The time at which the application manager 330 requests for the latest date/time may be previously set, for example, by a service provider or a user. For example, such time may be set to a predetermined time, such as in a constant cycle (i.e., at predetermined time intervals), at a time of activating the operation unit 20A, at a time of shutting down the operation unit 20A, or at a time when a user provides an instruction for the request. Furthermore, such time may be set up such that the application manager 330 requests for the latest activation date/time upon a certain amount of delay occurring in the start-up time of the operation unit.

Upon obtaining the list of application names, the launcher 340 extracts information of the latest activation date/time of each application from management information of the launcher 340 (S22) and transmits the information of the latest activation date/time to the application manager 330 (S23).

The application manager 330 compares the latest activation date/time obtained from the launcher 340 with a predetermined condition, so as to determine an application 210 to be saved again (S24). For example, as the predetermined condition, the application manager 330 determines an application which has not been activated for a week or more since the latest activation date/time to be an application 210 to be saved again.

In a case where there is an application 210 to be saved again, the application manager 330 notifies the installer 320 of the corresponding application name (S25).

When the application name of the saving target is notified by the application manager 330, the installer 320 (i.e., the uninstall unit) requests the application 210 for set value information (S26).

The application 210 generates a set value file and provides the set value file to the installer 320 (S27).

Subsequently, the installer 320 (i.e., the uninstall unit) requests the application 210 that is a saving target for uninstallation (S28).

Upon uninstallation, the application 210 requests the application manager 330 for de-registration (S29).

The application manager 330 deletes registration information of the uninstalled application 210 and provides the launcher 340 with registration-list information (i.e., icon information, application names, etc.) of remaining target apps that are managed as installed applications (S30).

The launcher 340 registers on the “home screen” or the “application-list screen” the registration-list information that is received from the application manager 330 (S31). Here, the launcher 340 deletes the icon of the application 210 that has been uninstalled.

The installer 320 (i.e., the dummy icon generator 223) transmits the dummy icon of the saving app to the launcher 340 (S32). For the dummy icon, one that is once generated is re-used. Note that, for the dummy icon, it is possible to use a newly generated one.

Upon receiving the dummy icon from the installer 320, the launcher 340 registers the dummy icon and the application name of the saving app corresponding to the dummy icon (S33). The application name of the saving app is the application name of the application 210 that is determined by the application manager 330 to be the saving target.

The installer 320 (i.e., the application saving unit 224) saves an installation package and the set value file of the uninstalled application 210 in a designated path of the saving memory (S34).

Furthermore, the installer 320 (i.e., the application saving unit 224) registers the application name and the designated path in an associated manner in the management table 1010 (c.f., FIG. 6) as information of the saving app (S35).

Then, when a touch-operation is provided by a user on the dummy icon on the “home screen” or the “application-list screen” as an instruction for activation, the processes from the step S2-16 of FIG. 7 is performed. The launcher 240 accepts activation of the dummy icon and, based on the acceptance, the operation unit 20 installs and activates the saving app corresponding to the dummy icon.

As described above, in the first variation example, even though an application that is set up to be subject to activation-time install is installed upon the first-time activation, the application may be saved again in a case where a predetermined condition is not met, such as where the application has not been activated for a predetermined period since then. As an application that is not frequently needed to be activated tends to be set up to be subject to activation-time install, it is possible to reduce increase in the number of applications to be activated by way of saving the application again in a case where the application has not been activated even after the application is once installed. This reduces increase in the start-up time of the operation unit 20 even after installation. The predetermined period of time may be set by, for example, a service provider or a user.

Furthermore, there is no limitation that an application to be saved again is set up to be subject to activation-time install. That is, an application that is subject to prompt install may be included.

Furthermore, in the first variation example, there is an explanation of an example in which a set value file is transmitted and received from an application to an installer. Regarding some applications that store set values, in a case where re-installation is normally performed, data of the set values is deleted, and therefore there is a need for entering the set values again at the time of re-installation. In such a way as explained in the first variation example, it is possible to recover set values at a time of re-installation after re-saving.

### Second Variation Example

Description in the above-described embodiment and in the first variation example has explained an example in which whether an application is subject to “prompt install” or “activation-time install” is determined, based on information of a statement provided by a developer in an information file of each application. However, instead of such a setting by a developer, a user who installs the application may conduct the setting.

For example, there is a case of installing an application to which a statement as to either one of “prompt install” and “activation-time install” is not provided in an information file. For such a case as above, there is provided a setting unit for displaying a configuration screen on the control panel when installing an application, so as to allow a user to set whether the application is subject to “prompt install” or “activation-time install” on the configuration screen. The installer may call the setting unit at the time of determination of the step S1 (c.f., FIG. 7), so as to read configuration information that is set up through the configuration screen and determine whether the application is subject to “prompt install” or “activation-time install”.

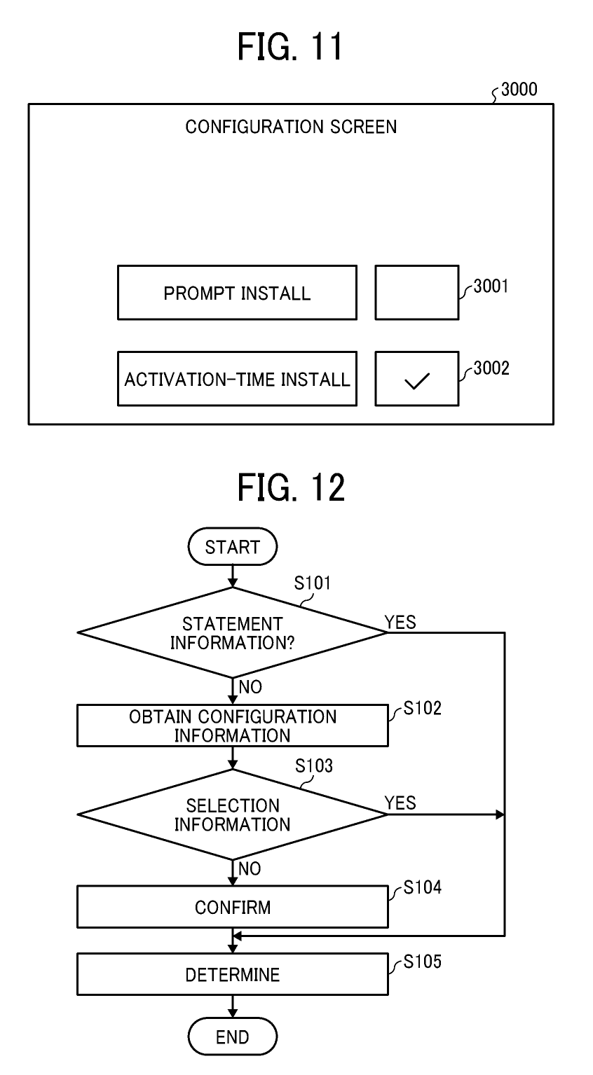

FIG. 11 is a diagram illustrating an example of a configuration screen according to the second variation example. The configuration screen 3000 illustrated in FIG. 11 is provided with check boxes 3001 and 3002 for setting as to either one of “prompt install” and “activation-time install”. When a user turns on either one of the check boxes 3001 and 3002, selection information (i.e., in the example of FIG. 11, “activation-time install” of the check box 3002) indicative of one that is turned on for the setting is written on configuration information.

Although the above description explains an example of a configuration screen provided with the check boxes 3001 and 3002 for setting as to either one of “prompt install” and “activation-time install”, the setting may be conducted on a per application basis. For example, there may be a list-displaying box displaying a list of the application names of setting targets. A user may select one of the application names from the list-displaying box for the sake of a setting of selection information as to either one of “prompt install” and “activation-time install” regarding the corresponding application. The selection information that is set through the configuration screen is written as configuration information in such a manner as associated with the selected application name.

FIG. 12 is a flowchart illustrating an example of a process flow of the process performed by an installer at the step S1. As illustrated in FIG. 12, the installer firstly reads an information file, to determine whether the information file includes statement information that states either one of “prompt install” and “activation-time install” (S101).

In a case where the statement information is included (S101: YES), whether the application is subject to “prompt install” or “activation-time install” is determined (S105), and a process (i.e., either one of the steps S2-1 and S2-11) that corresponds to the statement information is performed.

In a case where the statement information is not included (S101: NO), the configuration information is read (S102), to determine whether the selection information indicative of either one of “prompt install” and “activation-time install” is included in the configuration information (S103).

In a case where the selection information is included (S103: YES), either one of “prompt install” and “activation-time install” is determined as for the selection information (S105), and a process (i.e., either one of the steps S2-1 and S2-11) that corresponds to the selected one according to the selection information is performed.

In a case where the selection information is not included (S103: NO), a confirmation process is performed (S104). The confirmation process is a process for confirming the setting to either one of “prompt install” and “activation-time install”. In the confirmation process, the configuration screen 3000 (c.f., FIG. 11) may be displayed, to accept an input of selection. Further, it is possible to read a registration value to which a default value indicative of either one of “prompt install” and “activation-time install” is registered.

The above-described second variation example may be combined with any one of the above-described embodiment or the first variation example.

Note that, although description in the second variation example explains an example in which an item for setting either one of “prompt install” and “activation-time install” is provided on a configuration screen, there is no such limitation. Instead, there may be provided an item for always setting to prompt install, an item for always setting to activation-time install, etc.

Furthermore, there may be provided on the configuration screen an item (e.g., an item regarding a limitation period) for setting a condition for determining an application be saved again. In such case, for example, the application manager 330 reads the condition that is set up through the configuration screen at the step S24 (c.f., FIG. 10) to determine the application to be saved again.

As described above, by way of enabling a user to set up to either one of “prompt install” and “activation-time install” through a configuration screen, applications to be installed may be customized on a per user basis through the operation unit. Therefore, it is possible to provide a setting as appropriate, such that a user who desires to shorten the start-up time provides such a setting as prioritizing activation-time install and a user who does not mind the start-up time provides such a setting as prioritize prompt install.

Although the description in the above-described embodiment and each variation example explains an MFP on which an operation unit and a main unit are operated on respective OSs, there is no such limitation. The image processing apparatus may be an apparatus including at least one of such image processing functions as a copying function, a scanner function, a facsimile function, and a printer function.

Each function as explained in the embodiment and each variation example may be actualized by one or more processing circuits. Here, the “processing circuit” in the present specification may include a processor that is programmed to execute, based on software, each of the functions as explained above, such as a processor mounted on an electronic circuit, and a device that is designed to execute each of the functions as explained above, such as an application specific integrated circuit (ASIC), a digital signal processor (DSP), a field programmable gate array (FPGA), or a conventional circuit module.

Programs that are executed in the embodiment and each variation example are recorded in a computer-readable recording medium, such as a CD-ROM, a flexible disk (FD), a CD-R. or a digital versatile disk (DVD), as a file in an installable format or an executable format, when being provided.

Furthermore, the programs that are executed in the embodiment and each variation example may be configured to be stored in a computer that is connected to a network such as the Internet and provided by way of downloading via the network. Furthermore, the programs that are executed in each unit of the embodiment and each variation example may be configured to be provided or distributed via a network such as the Internet.

Furthermore, the programs in the embodiment and each variation example may be configured to be embedded in advance in the ROM, etc., when being provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

For example, in alternative to the MFP the above-descried installation process is applicable to any system or apparatus, provided with an operation unit that allows a user to install an application to extend functionality of a main unit.

Further, any one of the above-described operations may be performed in various other ways, for example, in an order different from the one described above.

In one example, the present invention may reside in: a non-transitory recording medium storing a program for causing a computer to perform a method for installing application, the method comprising: receiving a request for installing an application onto an execution device, the execution device being configured to execute one or more applications; determining, in response to receiving the installation request, whether the application to be installed is subject to prompt installation or activation-time installation; generating a dummy icon based on a determination that the application to be installed is subject to activation-time installation;
storing, in a memory, the application of which the dummy icon is generated; receiving a request for activating the application through the generated dummy icon; and installing and activating the application stored in the memory in response to receiving the activation request through the dummy icon.

1. A system for installing application, comprising:
one or more processors; and
one or more computer-readable media storing instructions which, when processed by the one or more processors, cause the processors to:
receive a request for installing an application onto an execution device, the execution device being configured to execute one or more applications;
determine, in response to receiving the installation request, whether the application to be installed is subject to prompt installation or activation-time installation;
generate a dummy icon based on a determination that the application to be installed is subject to activation-time installation;
store, in a memory, the application of which the dummy icon is generated;
receive a request for activating the application through the generated dummy icon; and
install and activate the application stored in the memory in response to receiving the activation request through the dummy icon.

2. The system according to claim 1, the processors being caused to:
promptly install the application based on a determination that the application to be installed is subject to prompt installation; and
receive a request for activating the application through an icon of the application that has been installed.

3. The system according to claim 2, the processors being further caused to:
determine whether the application is subject to prompt installation or activation-time installation, based on information indicative of whether the application is subject to prompt installation or activation-time installation that is previously set.

4. The system according to claim 1, the processors being further caused to:
uninstall the application that has been installed;
store again, in the memory, the application that has been uninstalled; and
receive a request for activating the application through a dummy icon of the application that has been uninstalled.

5. The system according to claim 4, the processors being further caused to:
obtain a set value of the application when the application is uninstalled; and
store, in the memory, the application that has been uninstalled and the set value.

6. The system according to claim 4, the processors being further caused to:
record activation-frequency information of the installed application;
determine whether to save the installed application, based on the recorded activation-frequency information; and
uninstall the installed application when the installed application is determined to be saved.

7. The system according to claim 6, the processors being further caused to determine whether to save the installed application at predetermined time intervals.

8. The system according to claim 6, the processors being further caused to determine the application to be saved, according to an amount of delay occurring in a start-up time of the execution device for executing the one or more applications.

9. The system according to claim 1, comprising:
an operation unit to accept a user operation, the operation unit being the execution device that executes the one or more applications; and
a main unit to perform various operations according to the user operation, the various operations including an image processing operation.

10. The system according to claim 9, wherein the operation unit and the main unit are incorporated into one apparatus.

11. A method for installing application, the method comprising:
receiving a request for installing an application onto an execution device, the execution device being configured to execute one or more applications;
determining, in response to receiving the installation request, whether the application to be installed is subject to prompt installation or activation-time installation;
generating a dummy icon based on a determination that the application to be installed is subject to activation-time installation;
storing, in a memory, the application of which the dummy icon is generated;
receiving a request for activating the application through the generated dummy icon; and
installing and activating the application stored in the memory in response to receiving the activation request through the dummy icon.

12. An image processing apparatus comprising:
accepting means for accepting an installation process of an application;
generating means for generating a dummy icon in response to acceptance of the installation process by the accepting means;
storing means for storing, in a saving memory, the application of which the dummy icon has been generated by the generating means;
activation accepting means for accepting activation of the application through the dummy icon generated by the generating means; and
activating means for installing and activating the application stored in the saving memory in response to acceptance of the activation of the application through the dummy icon by the activation accepting means.
